(19) United States
(12) Patent Application Publication
(10) Pub. No.: US 2009/0248910 A1
(43) Pub. Date: Oct. 1, 2009

(54) CENTRAL DMA WITH ARBITRARY PROCESSING FUNCTIONS

(75) Inventors: David G. Conroy, El Granada, CA (US); Timothy J. Millet, Mountain View, CA (US); Michael J. Smith, San Francisco, CA (US); Joshua P. de Cesare, Campbell, CA (US)

Correspondence Address: APPLE INC.;c/o Fletcher Yoder, PC, P.O. Box 692289, Houston, TX, 77269-2289, US

(73) Assignee: Apple Inc., Cupertino, CA (US)

(21) Appl. No.: 12/060,728

(22) Filed: Apr. 1, 2008

(51) Int. Cl. G06F 13/28

(52) U.S. Cl. 710/22

(57) ABSTRACT

A method and system is disclosed for transforming of data by a DMA controller without first saving the transmitted data on an intermediate medium. The method includes the DMA controller accessing data for transfer between an origination location in the system and a destination location in the system. The accessed data is passed through the DMA controller before being sent to the destination location. While the data is being passed through the DMA controller, it is transformed into a modified state. This transformation may include encryption or decryption of the data. The transformation may also include adding error correction bits to the data through an encoding process or decoding previously encoded data. Upon completion of the transformation, the data is sent directly to a prescribed destination location, typically either a memory circuit or an I/O device. Also disclosed is a DMA controller capable of performing the data transformation.

### BACKGROUND OF THE INVENTION

1. Field of the Invention

The present invention relates generally to transformation of data into a modified state during a direct memory access transfer.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Direct Memory Access (“DMA”) controllers are widely used in modern electronic devices. The DMA controller allows for data transfer in an electronic device without burdening the central processing unit (“CPU”). A CPU utilizes a list of commands, or instructions, to operate. These instructions are often grouped together as a program. Programs are typically stored in long term storage devices, such as a hard disk drive or non-volatile memory. Accessing these long term storage devices requires a certain amount of time, during which time the CPU must idly wait.

The use of a DMA controller can reduce the time a CPU must remain idle. Typically, the CPU hands off the fetching of a list of instructions that are grouped together as a program to a DMA controller. The CPU is then free to execute previously fetched instructions while the DMA fetches the program for the CPU. DMA controllers usually transfer data between a location in memory and an I/O device or between an I/O device and a location in memory. DMA controllers may also be used to transfer data between two locations in memory, or directly between I/O devices. The transfer of data by the DMA controller between some data source and to some data receiver is accomplished along a DMA channel. A DMA channel is a path between the DMA controller and a device. The DMA channel typically passes data, command signals, and a clock signal to the device.

It is important for data in a modern portable electronic device to be both secure from hackers and error free during operation. However, current efforts to secure data add overhead to a device in the form of system latency. Similarly, efforts to ensure uncorrupted data is available to a user of a device also add overhead to a device in the form of system latency. For example, data accessed during a DMA transfer may be slowed from having to be sent through security or error correction systems before the transfer may be completed. As such, there is a need for the ability to secure uncorrupted data without slowing down the operation of a device.

### SUMMARY

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

An electronic device having a DMA controller is provided. In one embodiment, the DMA controller is connected to a DMA bus, through which a plurality of I/O devices and storage devices may be accessed. The DMA controller may also be individually connected to a plurality of I/O devices and storage devices through a plurality of individually wired DMA channels. The I/O devices may share the bandwidth of the DMA bus while each communicating along a specified DMA channel. In one embodiment, the DMA controller contains cryptographic circuitry which may utilize decryption techniques to decrypt DMA transferred information and directly send the data to a requesting device. In this manner, there is a reduced opportunity for data to be hacked by an unauthorized user because the unencrypted data does not reside, unprotected, in the transferring device before being sent to the requesting device. The cryptographic circuitry also may utilize encryption techniques to encrypt data for secure storage of that data in the electronic device.

In another embodiment, the DMA controller contains error detection and correction circuitry which may utilize error correction codes to detect and correct errors in the DMA transferred data. The error detection and correction circuitry also may include error correction encoding circuitry, which allows the DMA controller to encode data for storage in the electronic device to aid in the error corrected retrieval of that data.

### BRIEF DESCRIPTION OF THE DRAWINGS

These and other features, aspects, and advantages of the present invention will become better understood when the following detailed description of certain exemplary embodiments is read with reference to the accompanying drawings in which like characters represent like parts throughout the drawings, wherein:

FIG. 1 is a perspective view illustrating an electronic device, such as a portable media player, in accordance with one embodiment of the present invention;

FIG. 2 is a simplified block diagram of the portable media player of FIG. 1 in accordance with one embodiment of the present invention;

FIG. 3 is a simplified block diagram of the portable media player of FIG. 1 in accordance with a second embodiment of the present invention;

FIG. 4 is a flowchart depicting the operation of a portable media player in performing a DMA transfer in accordance with an embodiment of the present invention;

FIG. 5 is a simplified block diagram of the DMA controller of FIGS. 1 and 2 in accordance with one embodiment of the present invention;

FIG. 6 is a flowchart depicting the operation of a DMA controller in accordance with an embodiment of the present invention;

FIG. 7 is a simplified block diagram of a DMA channel interface of FIG. 5 in accordance with one embodiment of the present invention;

FIG. 8 is a flowchart depicting the operation of the channel control logic during a DMA transfer.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

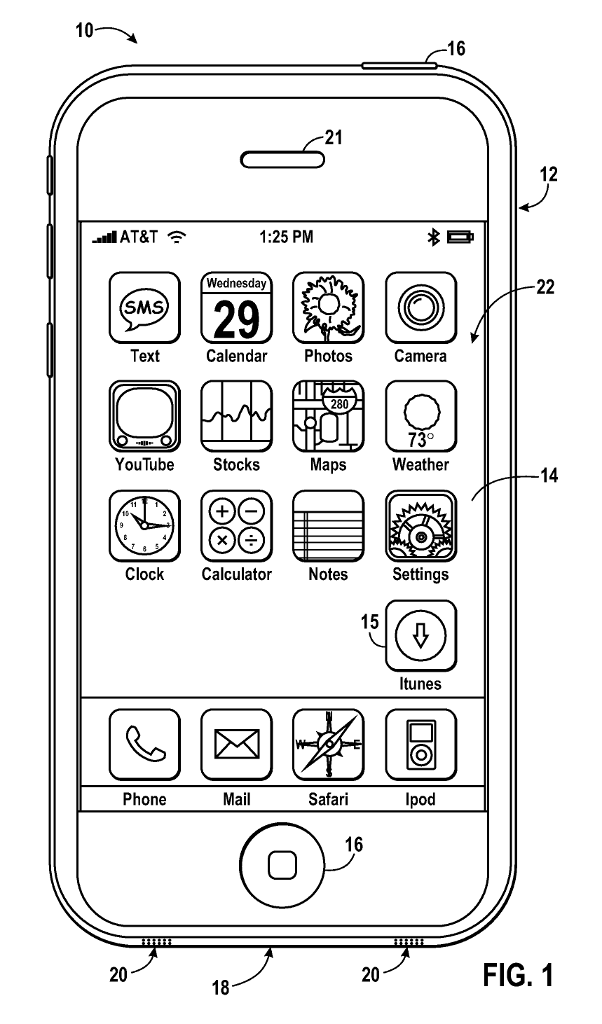

Turning now to the figures, FIG. 1 depicts an electronic device 10 in accordance with one embodiment of the present invention. In some embodiments, the electronic device 10 may be a media player for playing music and/or video, a cellular phone, a personal data organizer, or any combination thereof. Thus, the electronic device 10 may be a unified device providing any one of or a combination of the functionality of a media player, a cellular phone, a personal data organizer, and so forth. In addition, the electronic device 10 may allow a user to connect to and communicate through the Internet or through other networks, such as local or wide area networks. For example, the electronic device 10 may allow a user to communicate using e-mail, text messaging, instant messaging, or using other forms of electronic communication. By way of example, the electronic device 10 may be a model of an iPod3 having a display screen or an iPhone3 available from Apple Inc.

In certain embodiments the electronic device 10 may be powered by a rechargeable or replaceable battery. Such battery-powered implementations may be highly portable, allowing a user to carry the electronic device 10 while traveling, working, exercising, and so forth. In this manner, a user of the electronic device 10, depending on the functionalities provided by the electronic device 10, may listen to music, play games or video, record video or take pictures, place and take telephone calls, communicate with others, control other devices (e.g., the device 10 may include remote control and/or Bluetooth functionality, for example), and so forth while moving freely with the device 10. In addition, in certain embodiments the device 10 may be sized such that it fits relatively easily into a pocket or hand of the user. In such embodiments, the device 10 is relatively small and easily handled and utilized by its user and thus may be taken practically anywhere the user travels. While the present discussion and examples described herein generally reference an electronic device 10 which is portable, such as that depicted in FIG. 1, it should be understood that the techniques discussed herein may be applicable to any electronic device having a display, regardless of the portability of the device.

In the depicted embodiment, the electronic device 10 includes an enclosure 12, a display 14, user input structures 16, and input/output connectors 18. The enclosure 12 may be formed from plastic, metal, composite materials, or other suitable materials or any combination thereof. The enclosure 12 may protect the interior components of the electronic device 10 from physical damage, and may also shield the interior components from electromagnetic interference (EMI).

The display 14 may be a liquid crystal display (LCD) or may be a light emitting diode (LED) based display, an organic light emitting diode (OLED) based display, or other suitable display. In accordance with certain embodiments of the present technique, the display 14 may display a user interface 22 as well as various images, such as logos, avatars, photos, album art, and so forth. Additionally, in one embodiment the display 14 may be a touch screen through which a user may interact with the user interface. The display 14 may also display various function and/or system indicators to provide feedback to a user, such as power status, call status, memory status, etc. These indicators may be in incorporated into the user interface displayed on the display 14. As discussed herein, in certain embodiments the user interface 22 may be displayed on the display 14, and may provide a mechanism for a user to interact with the electronic device 10. The user interface may be a textual user interface, a graphical user interface (GUI), or any combination thereof, and may include various layers, windows, screens, templates, elements or other components that may be displayed in all of or areas of the display 14.

In one embodiment, one or more of the user input structures 16 are configured to control the device 10, such as by controlling a mode of operation, an output level, an output type, etc. For instance, the user input structures 1 6 may include a button to turn the device 10 on or off. In general, embodiments of the electronic device 10 may include any number of user input structures 16, including buttons, switches, a control pad, keys, knobs, a scroll wheel, or any other suitable input structures. The input structures 16 may work with a user interface displayed on the device 10 to control functions of the device 10 or of other devices connected to or used by the device 10. For example, the user input structures 16 may allow a user to navigate a displayed user interface or to return such a displayed user interface to a default or home screen.

The user interface 22 may, in certain embodiments, allow a user to interface with displayed interface elements via the one or more user input structures 16 and/or via a touch sensitive implementation of the display 14. In such embodiments, the user interface provides interactive functionality, allowing a user to select, by touch screen or other input structure, from among options displayed on the display 14. Thus the user can operate the device 10 by appropriate interaction with the user interface 22. The user interface 22 may of any suitable design to allow interaction between a user and the device 10. Thus, the user interface 22 may provide windows, menus, graphics, text, keyboards or numeric keypads, scrolling devices, or any other elements. In one embodiment, the user interface 22 may include screens, templates, and UI components, and may include or be divided into any number of these or other elements. The arrangement of the elements of user interface 22 may be hierarchical, such that a screen includes one or more templates, a template includes one or UI components. It should be appreciated that other embodiments may arrange user interface elements in any hierarchical or non-hierarchical structure.

The electronic device 10 may also include various input and output ports 18 to allow connection of additional devices. For example, a port 18 may be a headphone jack that provides for connection of headphones. Additionally, a port 18 may have both input/output capabilities to provide for connection of a headset (e.g. a headphone and microphone combination). Embodiments of the present invention may include any number of input and/or output ports, including headphone and headset jacks, universal serial bus (USB) ports, Firewire or IEEE-1394 ports, and AC and/or DC power connectors. Further, the device 10 may use the input and output ports to connect to and send or receive data with any other device, such as other portable electronic devices, personal computers, printers, etc. For example, in one embodiment the electronic device 10 may connect to a personal computer via a Firewire or IEEE-1394 connection to send and receive data files, such as media files.

The electronic device 10 may also include various audio input and output portions. For example, an input receiver 20 may be a microphone that receives user audio input. Additionally, an output transmitter 21 may be a speaker that transmits audio signals to a user. The input receiver 20 and the output transmitter 21 may be used in conjunction as audio elements of a telephone.

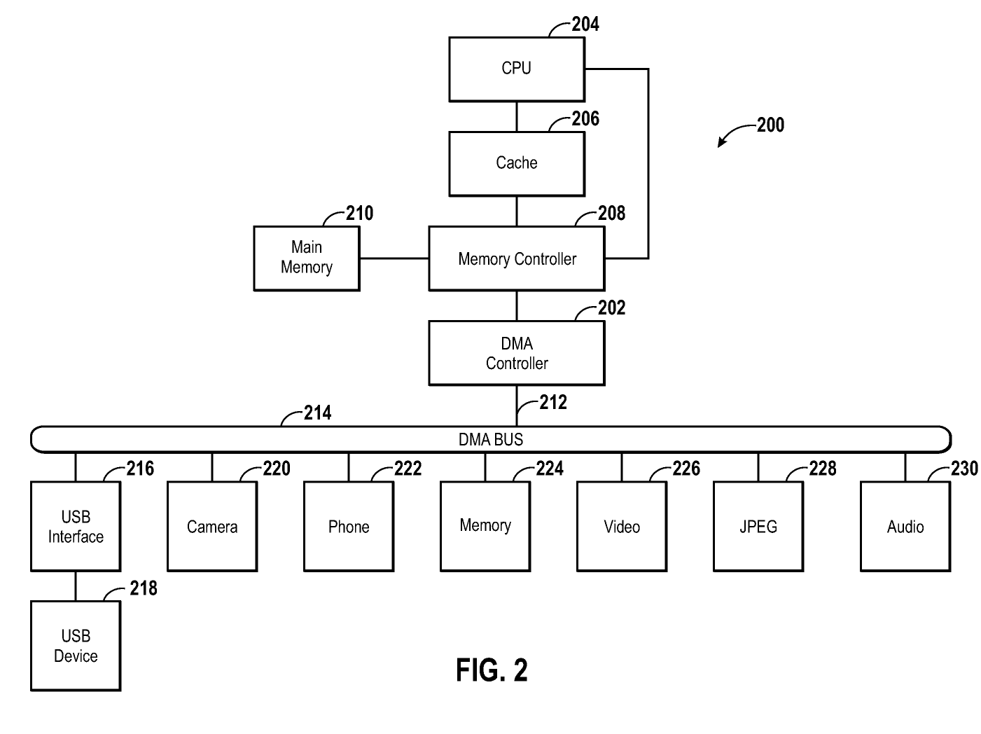

Turning now to FIG. 2, a block diagram 200 of components of an illustrative electronic device 10 is shown. The block diagram includes a DMA controller 202 connected to a central processing unit (“CPU”) 204. The CPU 204 may include a single processor or it may include a plurality of processors. In another embodiment, the CPU 204 may include one or more “general-purpose” microprocessors, a combination of general and special purpose microprocessors, and/or ASICS. For example, the CPU 204 may include one or more reduced instruction set (RISC) processors, as well as graphics processors, video processors, and/or related chip sets. The CPU 204 may provide the processing capability required to execute the operating system, programs, the user interface 22, and any other functions of the device 10. The CPU 204 may also include non-volatile memory, such as ROM, which may be used to store the firmware for the device 10, such as an operating system for the device 10 and/or any other programs or executable code necessary for the device 10 to function.

The CPU 204 may be connected to a cache memory 206, which may be used as a temporary storage location for data which is to be rapidly accessed by the CPU 204. The cache memory 206 may be connected to the memory controller 208, which regulates the flow of data and instructions between the main memory 210 and the cache memory 206, or, if the need for the data and instructions is urgent or the data and instructions are prohibited from being temporarily stored in the cache memory 206, directly between the main memory 210 and the CPU 204. In one embodiment, the flow of data and instructions between the DMA controller 202 and the memory controller 208 is done without determining the contents of the cache memory 206. In another embodiment, the flow of data and instructions between the DMA controller 202 and the memory controller 208 is accomplished after determining the current contents of cache memory 206. In a further embodiment, the DMA controller 202 may be directly connected to the CPU 204. Moreover, the accessing of data for storage in the main memory 210 and the cache memory 206 may be performed over secondary busses separate from the operation of the DMA controller 202.

The DMA controller 202 may operate as a control device for the transfer of data between the I/O devices, e.g. the USB device 218 and the audio circuitry 230, between the main memory 210 and an I/O device, e.g. the audio circuitry 230, or between an I/O device, e.g. the audio circuitry 230, and the main memory 210. It is envisioned that the particular DMA controller 202 utilized may have other functions as described in the copending and commonly assigned U.S. patent application Ser. No. ______, filed ______, entitled, “Clock Control for DMA Busses,” the disclosure of which is hereby incorporated by reference in its entirety. Such functions are hereby incorporated by reference. The DMA controller 202 may be connected to a DMA bus 214 by way of a DMA interconnect 212. The DMA interconnect 212 acts to transmit data, command, and clock signals, as well as receive DMA request signals and transferred data from a target I/O device. These transmitted and received signals may be collectively referred to as “DMA transfer signals.” The DMA interconnect 212 also receives command and data signals transmitted via the DMA bus 214 from the I/O devices. The DMA bus 214 acts as a conduit for the DMA transfer signals and for the command and data signals from the I/O devices. The DMA bus 214 may include a plurality of DMA channels. Each DMA channel may be a path connecting the DMA controller 202 to any specific I/O device. In one embodiment, these paths may be active simultaneously, in effect, sharing the DMA bus 214.

The DMA bus 214 may be connected to a plurality of devices such as a USB (“Universal Serial Bus”) device 218 through a USB interface 216, the camera circuitry 220, the phone circuitry 222, the video circuitry 226, the JPEG (Joint Photographic Experts Group) circuitry 228, and the audio circuitry 230. Additional circuitry such as user interface circuitry and display circuitry corresponding to elements pictured in FIG. 1 may also be connected to the DMA bus 214. Furthermore, a long term memory 224 may be connected to the DMA bus 214. The long term memory 224 may be non-volatile memory such as flash memory, magnetic drives, optical drives, or read only memory circuitry. The long term memory 224 may store data files such as media (e.g., music and video files), software (e.g., for implementing functions on device 10), preference information (e.g., media playback preferences), wireless connection information (e.g., information that may enable media device to establish a wireless connection such as a telephone connection), subscription information (e.g., information that maintains a record of podcasts or television shows or other media a user subscribes to), telephone information (e.g., telephone numbers), and any other suitable data.

The USB interface 216 may be connected to a USB device 218. This USB device 218 may be, for example, an external flash memory circuit or an external hard disk drive. The camera circuitry 220 may allow a user to take digital photographs. The phone circuitry 222 may allow a user to receive or make a telephone call. In one embodiment, the phone circuitry 222 may interact with the input receiver 20 and the output transmitter 21 of FIG. 1 to complete a telephone call. The video circuitry 226 may be used to encode and decode video samples, either taken by the user in conjunction with the camera circuitry 220, or downloaded from an external source such as the internet. Similarly, the JPEG circuitry 228 may allow for encoding and decoding of pictures taken by the user in conjunction with the camera circuitry 220, or downloaded from an external source such as the internet. Finally, the audio circuitry 230 may allow for the playing of audio files such as compressed music files.

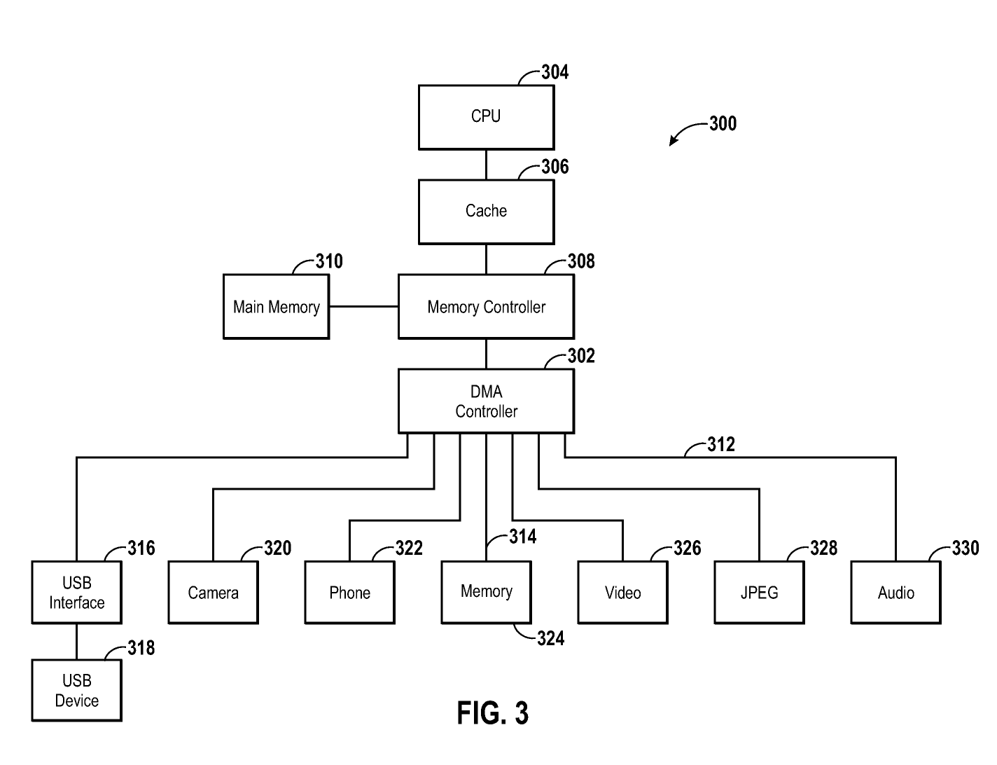

Turning now to FIG. 3, a block diagram of components of an illustrative electronic device 10 is shown. The block diagram includes a DMA controller 302 connected to a CPU 304. The CPU 304 may include a single processor or it may include a plurality of processors. In another embodiment, the CPU 304 may include one or more “general-purpose” microprocessors, a combination of general and special purpose microprocessors, and/or ASICS. For example, the CPU 304 may include one or more reduced instruction set (RISC) processors, as well as graphics processors, video processors, and/or related chip sets. The CPU 304 may provide the processing capability required to execute the operating system, programs, the user interface 22, and any other functions of the device 10. The CPU 304 may also include non-volatile memory, such as ROM, which may be used to store the firmware for the device 10, such as an operating system for the device 10 and/or any other programs or executable code necessary for the device 10 to function.

The CPU may be connected to a cache memory 306, which may be used as a temporary storage location for data which is to be rapidly accessed by the CPU. The cache memory 306 may be connected to the memory controller 308, which regulates the flow of data and instructions between the main memory 310 and the cache memory 306. Moreover, if the need for the data and instructions is urgent or the data and instructions are prohibited from being temporarily stored in the cache memory 306, the memory controller 308 may also regulate the flow of data and instructions directly between the main memory 310 and the CPU 304. In one embodiment, the flow of data and instructions between the DMA controller 302 and the memory controller 308 is done without determining the contents of the cache memory 306. In another embodiment, the flow of data and instructions between the DMA controller 302 and the memory controller 308 is accomplished after determining the current contents of cache memory 306. In a further embodiment, the DMA controller 302 may be directly connected to the CPU 304. Moreover, the accessing of data for storage in the main memory 310 and the cache memory 306 may be performed over secondary busses separate from the operation of the DMA controller 302.

The DMA controller 302 may operate as a control device for the transfer of data between the I/O devices, e.g. the USB device 318 and the audio circuitry 330, between the main memory 310 and an I/O device, e.g. the audio circuitry 330, or between an I/O device, e.g. the audio circuitry 330, and the main memory 310. Each DMA channel may be a path connecting the DMA controller 302 to any specific I/O device. The DMA controller 302 may be connected to a plurality of I/O devices along a plurality of independent DMA channels, e.g. the independent DMA channel line 312. The independent DMA channel line 312 is representative of a particular DMA path with an I/O device. The independent DMA channel line 312 may be used to transmit data, command, and clock signals from the DMA controller 302 to the USB device 318 by way of the USB interface 316. The USB device 318 may be, for example, an external flash memory circuit or an external hard disk drive. The independent DMA channel line 312 also may be used to transmit DMA request signals and data from the I/O device (for example, the USB device 318 via the USB interface 316) to the DMA controller 302.

The DMA controller 302 also may be connected to a plurality of devices such as the camera circuitry 320, the phone circuitry 322, the video circuitry 326, the JPEG circuitry 328, and the audio circuitry 330 along the independent DMA channel lines. Additional circuitry such as user interface circuitry and display circuitry corresponding to elements pictured in FIG. 1 may also be connected to the DMA controller 302. The camera circuitry 320 may allow a user to take digital photographs. The phone circuitry 322 may allow a user to receive or make a telephone call. In one embodiment, phone circuitry 22 may interact with the input receiver 20 and output transmitter 21 of FIG. 1 to complete a telephone call. The video circuitry 326 may be used to encode and decode video samples, either taken by the user in conjunction with the camera circuitry 320, or downloaded from an external source such as the internet. Similarly, the JPEG circuitry 228 may allow for encoding and decoding of pictures taken by the user in conjunction with the camera circuitry 320, or downloaded from an external source such as the internet. The audio circuitry 330 may allow for the playing of audio files such as compressed music files.

Similarly, an independent DMA channel line 314 is representative of a DMA channel connected to a long term memory 324. The independent DMA channel line 314 may be used to transmit data, command, and clock signals from the DMA controller 302 to the long term memory 324. The long term memory 324 may be non-volatile memory such as flash memory, magnetic drives, optical drives, or read only memory circuitry. The long term memory 324 may store data files such as media (e.g., music and video files), software (e.g., for implementing functions on device 10), preference information (e.g., media playback preferences), wireless connection information (e.g., information that may enable media device to establish a wireless connection such as a telephone connection), subscription information (e.g., information that maintains a record of podcasts or television shows or other media a user subscribes to), telephone information (e.g., telephone numbers), and any other suitable data. The independent DMA channel line 314 also may be used to transmit DMA request signals and data from the long term memory 324 to the DMA controller 302.

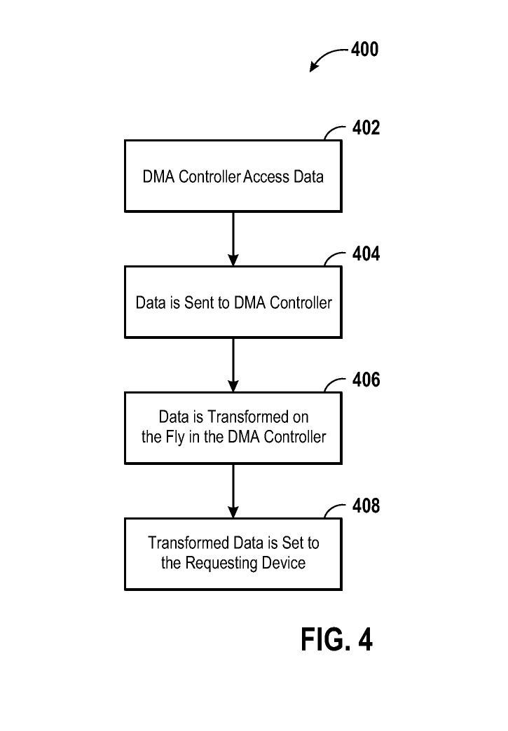

FIG. 4 depicts a flowchart representing a method 400 showing a DMA transfer in accordance with an embodiment of the present invention. The steps will first be discussed in conjunction with the system outlined in FIG. 3. In step 402, the DMA controller 302 receives a data transfer request from a requesting device, for example the audio circuitry 330. The DMA controller determines the location of the requested data. This location is the target device. This target device, for example, could be the long term memory 324. The DMA controller 302 may activate a DMA channel clock along the independent DMA channel line 312 corresponding to the requesting device, for example, the audio circuitry 330, and the independent DMA channel line 314 corresponding to the target device, for example, the long term memory 324. The DMA controller 302 may then initiate a DMA transfer from the target device by sending a channel clock and DMA command signals to the target device along independent DMA channel line 314.

In step 404, the target device receives the DMA channel clock and the command signals and transmits the requested data to the DMA controller 302. The DMA controller 302 receives this transmitted data and subsequently, in step 406, the transmitted data is transformed in the DMA controller 302 without first saving the transmitted data on an intermediate medium.

In one embodiment, the transformation of data in step 406 is accomplished by use of cryptographic circuitry contained in the DMA controller 302. The cryptographic circuitry may utilize decryption techniques to decrypt the DMA transmitted data. In this manner, there is a reduced opportunity for data to be hacked by an unauthorized user because the data does not reside, unprotected, anywhere before being sent to the requesting device. For example, if the long term memory 324 is the target device and the audio circuitry 330 is the requesting device, traditionally, the decryption circuitry would copy the data from the long term storage 324 into a temporary buffer in the main memory 310, and would then decrypt the data from the temporary buffer in the main memory 310 into a second buffer in the main memory 310. Finally, the decryption circuitry would then copy the decrypted data from the second buffer in main memory to the audio circuitry 330. This would leave the data temporarily exposed in an unencrypted format in the temporary buffers in the main memory 310. Utilizing the current method 400, the data to be accessed is never exposed in an unencrypted format. Instead, decryption of data in the DMA controller 302 without first saving the transmitted data on an intermediate medium allows for the decrypted data to be sent directly to the audio circuitry 330 in step 408 without temporarily storing the data to be transferred in an unencrypted format. The cryptographic circuitry may also include encryption techniques to encrypt data for secure storage of that data in the electronic device 10. In one embodiment, the cryptographic circuitry includes Advanced Encryption Standard compliant circuitry. In a further embodiment, hash functions may be employed by the cryptographic circuitry. In another embodiment, the cryptographic circuitry may be used to decrypt FairPlay® encrypted data. Upon transforming the transmitted data either through encryption or decryption techniques, the transformed data is sent to the requesting device in step 408.

In another embodiment, the transformation of data in step 406 is accomplished by use of error detection and correction circuitry contained in the DMA controller 302. The error detection and correction circuitry may utilize error correction and detection decoding circuitry. The correction and detection decoding circuitry may utilize error correction codes to detect and correct errors in the DMA transferred data. The error detection and correction circuitry also may include error detection and correction encoding circuitry, which allows the DMA controller 302 to encode data for storage in the electronic device to aid in the error correction retrieval of that data. In one embodiment, the error detection and correction circuitry makes use of linear block encoding and decoding. A further embodiment utilizes specialized subclasses of binary BCH codes, such as Hamming codes, to perform the error detection and correction in the error detection and correction circuitry. Another embodiment utilizes nonbinary BCH codes, such as Reed-Solomon codes, to perform the error detection and correction of the data in the error detection and correction circuitry. The error detection and correction circuitry may also employ checksums to detect errors in the transmitted data. Upon transforming the transmitted data either through error encoding or decoding techniques, the transformed data is sent to the requesting device in step 408.

Method 400 may operate in a substantially similar manner with respect to system 200. However, method 400, when used in conjunction with system 200, may utilize the DMA bus 214 to perform steps 402-412 instead of utilizing dedicated and independent DMA channel lines (for example, channel lines 312 and 314), as described above.

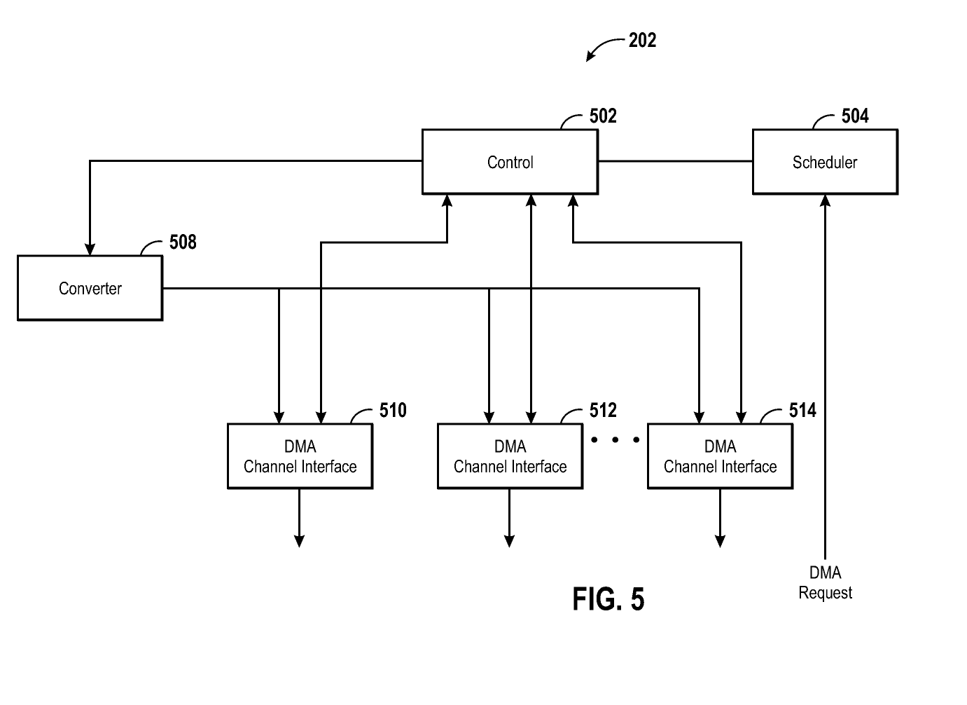

FIG. 5 depicts a simplified block diagram of the DMA controller of FIGS. 2 and 3 in accordance with one embodiment of the present invention. The DMA controller 202 is illustrated in FIG. 5, however, FIG. 5 also may alternatively correspond to the DMA controller 302. The DMA controller 202 includes control circuitry 502. The DMA controller 202 is capable of initializing DMA transfers, managing all DMA channels, and managing the DMA channel clocks, as well as DMA bus 214, by utilizing the control circuitry 502. The DMA controller 202 is able to perform these functions through the control circuitry 502 because the DMA controller 202 is the master of the DMA bus 214. Similarly, the DMA controller 302 is master of the independent DMA channel lines, e.g. 312 and 314. Therefore, the DMA controller 202 recognizes any and all devices utilizing the DMA bus 214 and can determine specific DMA transfer characteristics based on this knowledge. Similarly, the DMA controller 302, recognizes any and all devices utilizing the independent DMA channel lines, e.g. 312 and 314, and can determine specific DMA transfer characteristics based on this knowledge.

The scheduler 504 assists in determining when devices are utilizing the DMA bus 214 or the independent DMA channel lines, e.g. 312 and 314. The control circuitry 502 receives information pertaining to transfer device DMA requests from the scheduler 504. In one embodiment, the scheduler 504 can reside inside the control circuitry 502. In another embodiment, any DMA requests are sent along each independent DMA channel line, e.g. 312, and are passed to the scheduler 504 by way of the specified DMA channel interface, e.g. 510. The scheduler 504 operates to determine which DMA request for data transfers shall be given priority. In one embodiment, the requests are processed by way of a first-in-first-out methodology. In another embodiment, each channel is given a weight value. The higher the weight value assigned to a particular DMA channel, the higher scheduling priority that channel receives for a particular DMA transfer.

The DMA controller also includes a converter 508. The converter 508 may include cryptographic circuitry. The converter 508 may also include error detection and correction circuitry. The converter 508 may receive data from DMA interfaces 510-514 and transform the data without first saving the transmitted data on an intermediate medium. Once the transformation is complete, the converter 508 may send the transformed data back to the DMA interface 510-514 from which the data issued. Control circuitry 502 may interact with the converter 508. This interaction may include activation of encryption or decryption circuitry in the converter 508. This interaction may also include activation of encoding or decoding circuitry in the converter 508.

The DMA channel clock and DMA command signals may be sent as an input to a specified DMA channel interface, e.g. the DMA channel interface 510. The DMA interfaces 510-514 may also receive signals from the converter 508. In one embodiment, the signals received from the converter 508 include transformed data signals. The DMA interfaces 510-514 also may transmit signals to the control circuitry 502 and to the converter 508. In one embodiment, the signals transmitted to the converter 508 include data signals transmitted from a target device. The DMA interfaces 510-514 further may transmit and receive data along an independent DMA channel line, e.g. 312. The DMA interfaces 510-514 may also transmit and receive data along a DMA channel to a target device on a shared line, such as a DMA interconnect 212. In one embodiment, there exists a specific DMA channel interface corresponding to every DMA channel.

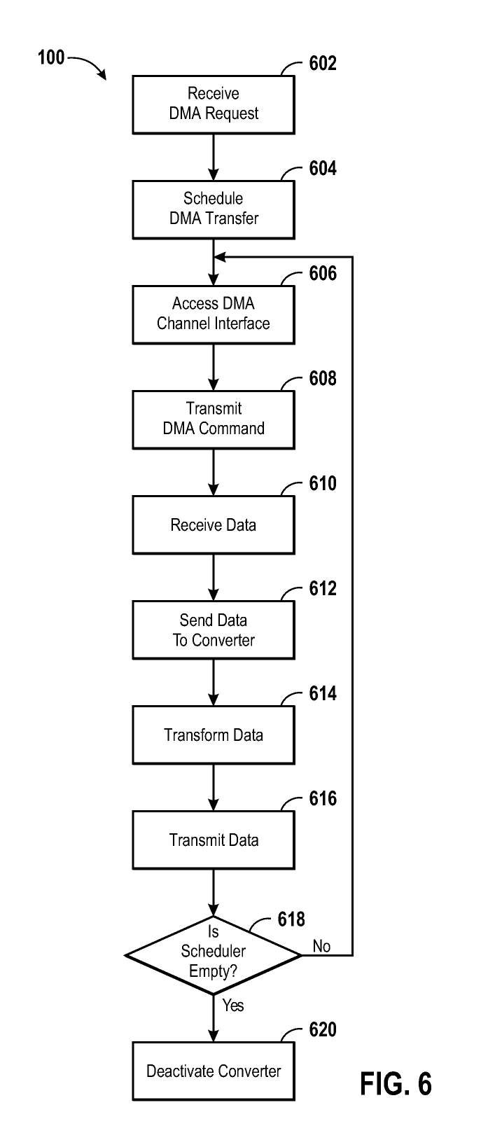

FIG. 6 depicts a flowchart representing a method 600 showing a DMA transfer in accordance with an embodiment of the present invention. The steps will first be discussed in conjunction with the system outlined in FIG. 5. In step 602, the scheduler 504 receives a DMA transfer request from a requesting device, for example the audio circuitry 330. The scheduler 504 may also receive a secondary DMA request in step 602.

In step 604, the scheduler 504 may schedule a DMA transfer. In one embodiment, this may be done using a FIFO (first-in-first-out) methodology. That is, the DMA transfers may be scheduled according to the order in which they are received by the scheduler 504. In a second embodiment, the scheduler 504 may schedule received DMA transfer requests based upon a ranking system. In this embodiment, each requesting device is assigned a priority ranking. A device with a high priority ranking will have its DMA transfer request scheduled before the DMA transfer request of a low priority device. All DMA transfer requests with a priority lower than the high priority DMA transfer request will be queued according to their respective priority ranking. In another embodiment, DMA transfer requests with a certain priority will cause the scheduler 504 to interrupt any DMA transfer currently being processed. In this manner, DMA transfers that must occur in real time may be completed on schedule.

Once the scheduler 504 determines which DMA transfer request is to be processed, the appropriate DMA transfer request information is sent to the control circuitry 502. In one embodiment, this information may include the target device information and the data to be retrieved. The control circuitry 502 may then utilize this information to access the appropriate DMA channel interface in step 606. In one embodiment of step 606, the control circuitry 502 determines the location of the data to be received and activates the corresponding DMA channel interface, e.g. 510. Subsequently, the control circuitry 502 may send activation signals to the converter 508. These activation signals may activate the converter 508. Activation of the converter 508 may include enabling error detection and correction encoding circuitry, enabling error detection and correction decoding circuitry, enabling encryption circuitry, or enabling decryption circuitry in the converter 508.

In addition to receiving a channel clock, the selected DMA interface, e.g. 510, may receive DMA command signals from the control circuitry 502. In step 608, the selected DMA interface, e.g. 510, may transmit a DMA transfer command and a DMA channel clock along a DMA channel to a target device on an independent DMA channel line, such as 312. The selected DMA interface, e.g. 510, may also transmit a DMA transfer command and a channel clock along a DMA channel to a target device on a shared line, such as DMA interconnect 212 to the shared DMA bus 214 (FIG. 2).

The target device, e.g. 318, receives the DMA transfer information, and in response, transmits the requested data back to the initiating DMA channel interface, e.g. 510. In step 610, the data transmitted from the target device is received by the selected channel interface, e.g. 510. Once the data is received, the control circuitry 502, may issue a command to the channel interface, e.g. 510, to send the received data from the target device to the converter 508. In step 612, the DMA channel interface, e.g. 510, transmits the data received from the target device to the converter 508.

The converter 508 receives the data from the transmitting DMA interfaces, e.g. 510, and in step 614, the converter 508 transforms the data without first saving the transmitted data on an intermediate medium. This transformation may include error detection and correction encoding of the data, error detection and correction decoding of the data, encryption of the data, or decryption of the data. In one embodiment, the transformation utilizes Advanced Encryption Standard cryptography techniques. In a further embodiment, hash functions may be employed in encrypting or decrypting the data. In another embodiment, the converter 508 may transform data according to FairPlay® decryption techniques. The converter 508 may also transform the data through encoding and decoding techniques utilizing linear block encoding and decoding, binary BCH codes such as Hamming codes, nonbinary BCH codes such as Reed-Solomon codes, or checksums.

Once the transformation is complete, in step 616, the converter 508 may send the transformed data back to the particular DMA interface, e.g. 510, from which the data issued, whereby the transformed data is transmitted to the requesting device.

Once the last of the requested data has been transmitted to the requesting device, the control circuitry 502 determines if the scheduler is empty in step 618. That is, the control circuitry 502 determines if the scheduler has any scheduled DMA transfers remaining in its queue. If scheduled DMA transfers exist in the scheduler queue, then the above described process is repeated, as shown in FIG. 6 by the arrow going from step 618 back to the flow diagram 600 between steps 604 and 606. If the scheduler is empty, the control circuitry 502 sends deactivation signals to the converter 508. These deactivation signals may deactivate the converter 508, as well as the associated DMA channels being used in the data transfers, in step 620.

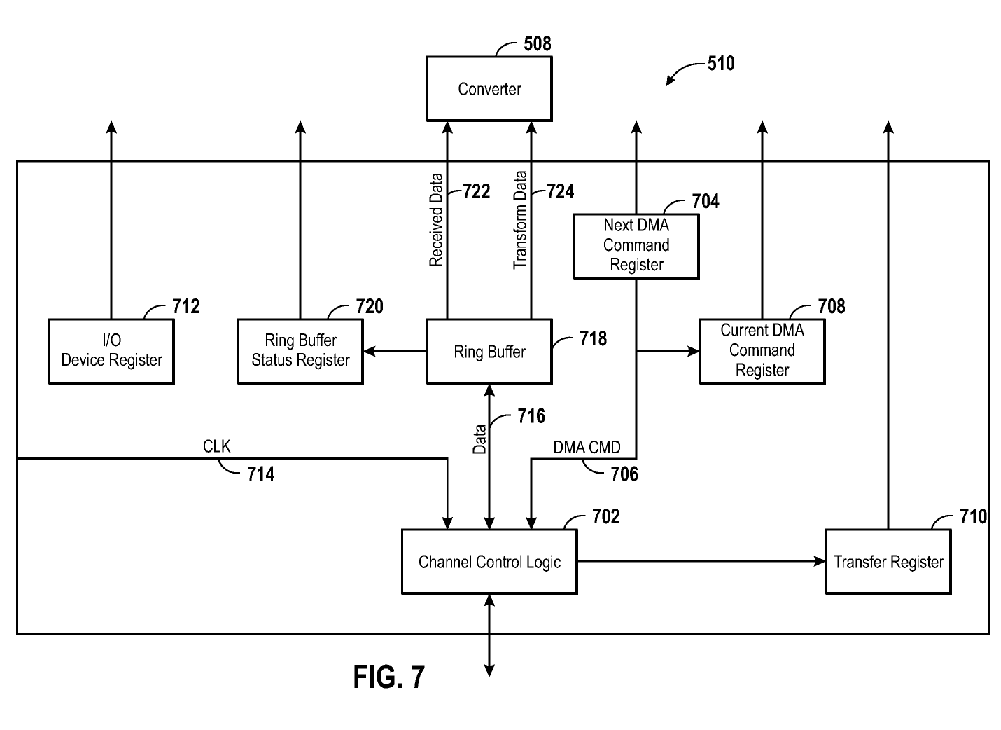

FIG. 7 is a simplified block diagram of a DMA channel interface 510 of FIG. 5 in accordance with one embodiment of the present invention. In one embodiment, the channel control logic 702 is used to configure and control the DMA channel. For example, the channel control logic 702 may deactivate the associated DMA channel at any given time, thus aborting any DMA transfer currently underway. In another embodiment, the channel control logic 702 is used in reporting the status of the DMA channel. For example, if an error occurs while the DMA channel is in use, or if a stoppage occurs during the use of the DMA channel, the channel control logic 702 may abort the current transfer, log, and report the failure. The channel control logic 702 may receive a channel clock along clock line 714. The channel control logic 702 may both transmit and receive data across data line 716. Furthermore, the channel control logic 702 may also receive DMA command signals along command line 706.

The DMA command signals are issued to the channel control logic 702 across command line 706 from the next DMA command register 704. The next DMA command register 704 may act as a queue for DMA commands that are to be sent to the channel control logic 702. These DMA commands may include the address of data that the DMA controller 202 will read from a target device. The DMA commands may also include the address of data that the DMA controller 202 will write to in a requesting device. The DMA commands may also include halt commands or startup commands for the channel control logic 702.

When a DMA command has been executed, the next command in the queue located in the next DMA command register 704 issues along command line 706 to the channel control logic 702. The command line 706 is monitored by the current DMA command register 708. The current DMA command register 706 may store a copy of the current DMA command being executed. This information may be used, for example, if the DMA transfer is stopped for any reason. The control circuitry 502 may access the current DMA command register 708 to determine the transfer that was in process when the stoppage occurred. Similarly, the transfer register 710 may access the data being transferred during a DMA transfer. For example, the transfer register 710 may determine how many bytes were actually transferred by the DMA controller 202 before a stoppage occurred. This allows control circuitry 502 to determine how much data was successfully moved from the target device to the requesting device.

The DMA channel interface 510 also includes an I/O device register 712. The I/O device register 712 may contain some I/O device control information. For example, the I/O device register 712 may contain information as to the width of data that the I/O device may transfer or accept. This information may be useful in determining the number of bytes to be transferred across the DMA channel. The I/O device register 712 may also include information as to the minimum channel clock frequency required for a DMA transfer along the DMA channel with a specified I/O device. This information may be used by the control circuitry 502 for setting the DMA clock frequency in the clock manager 512.

Data line 716 is connected to the ring buffer 718 through which data flows. In this manner, data is passed to the ring buffer 718 from the target device, by way of the channel control logic 702, and is transmitted to the requesting device from the ring buffer 718. The ring buffer 718 may be large enough so that a full cache line can fit into it. In one embodiment, the ring buffer may be either 32 or 64 bytes in size. In another embodiment, the ring buffer 718 is as large as the largest data packet transmittable by any of the I/O devices. In a further embodiment, the ring buffer 718 may be partitioned. For example, the ring buffer 718 may include a first partition capable of holding one or more blocks of pre-transformed data. A second partition would be similarly capable of holding blocks of post-transformed data. The partitions may be sized according to the needs of the converter 508. For example, Advanced Encryption Standard cryptographic circuitry requires data to be sent to it in 16 byte blocks. As such, the partitions of the ring buffer 718 may be made to accommodate the requirements of the transformation circuitry in the converter 508.

The ring buffer 718 may be coupled to converter 508 by way of a received data line 722 and a transformed data line 724. In one embodiment, the received data line 722 may be coupled to a first partition of the ring buffer 718, while the transformed data line 724 may be coupled to a second partition of the ring buffer. In a further embodiment, a single bidirectional bus may be used instead of independent unidirectional received data line 722 and transformed data line 724. A ring buffer status register 720 may also be employed to determine how much data is in the ring buffer 718. This makes it possible, for example, to determine how much data has been transferred out of the ring buffer 718 in situations where the DMA transfer is stopped.

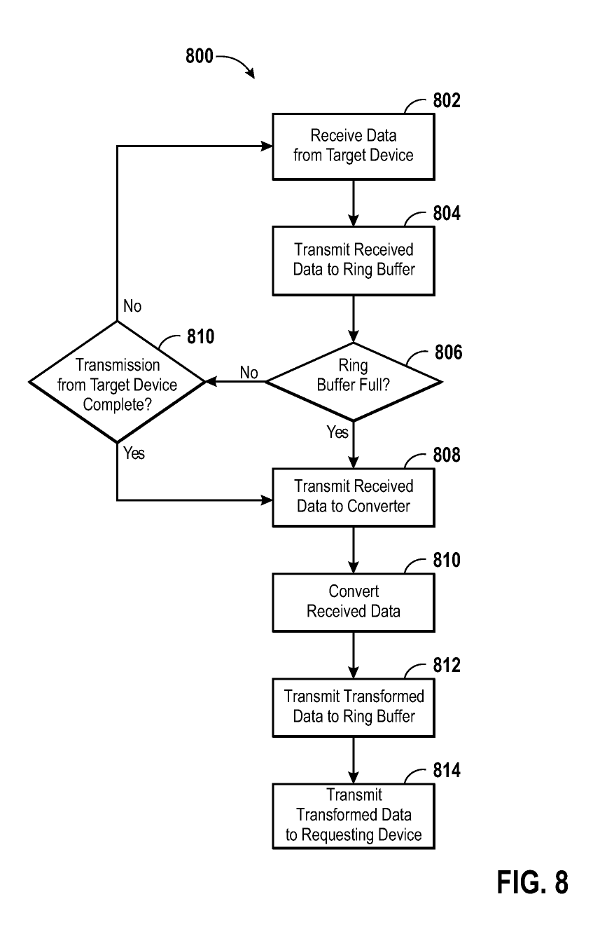

FIG. 8 is a flowchart 800 depicting the operation of the channel control logic 702 subsequent to issuing a DMA transfer. In step 802, the channel control logic 702 receives the requested data from the target device. In step 804, the data is transmitted from the channel control logic 702 to the ring buffer 718. In one embodiment, this transfer is to queue the data so that it can be transferred to the requesting device at a size appropriate for the requesting device. In another embodiment, this transfer is to queue the data so that it can be transferred to the converter 508 at a size appropriate for the converter 508. For example, if the transfer device sends data in 8 byte blocks and the converter 508 requires data to be received in 16 byte blocks for proper operation, then the ring buffer 718 may be used to form a single 16 byte block of data from two 8 byte blocks of data transmitted to the channel control logic 702.

In step 806, the channel control logic 702 determines if the ring buffer 718 is full. In one embodiment, the ring buffer 718 is full when no other data may be placed into the ring buffer 718. In a second embodiment, the ring buffer 718 is full when data is formed into a size appropriate for the converter 508 to receive. In another embodiment, the ring buffer 718 is full only when a first partition capable of holding pre-transformed data is full. If the ring buffer 718 is full, the channel control logic 702 transmits the ring buffered data to the converter 508 in step 808. The transmission of the ring buffered data may occur along received data line 722. If, however, the ring buffer 718 is not full, the channel control logic 702 determines if the transmission from the target device is complete in step 810. If the transmission from the target device is complete, then the ring buffer 718 transmits the ring buffered data to the converter 508 in step 808. If, however, the transmission from the target device is not complete, then the channel control logic 702 repeats the steps outlined above in flowchart 800 beginning with step 802.

After the data is transmitted by the ring buffer 718 to the converter 508 in step 808, the converter 508 may convert the received data in step 810. This conversion may be accomplished with the use of registers that specify the algorithm and key used in an encryption or decryption operation. Similarly, the registers in the converter may specify the error correction code used in the encoding or decoding of the data. In the cryptographic configuration, the converter 508 may also include registers, which may hold initialization vectors for use by the cryptographic circuitry. The registers may also hold N-byte keys used by the cryptographic circuitry. In one embodiment, these keys may be of a symmetric-key type. In another embodiment, these keys may be of an asymmetric (public) key type.

Once the data is converted by the converter 508 in step 810, the converter transmits the transformed data to the ring buffer 718 in step 812. The transformed data may be transmitted along transformed data line 724. In one embodiment, this transfer is to queue the data in the ring buffer 718 so that the transformed data may be transmitted to the requesting device at a size appropriate for the requesting device. For example, if the converter 508 sends data in 16 byte blocks and the requesting device reads data in 32 byte blocks, then the ring buffer 718 may be used to form a single 32 byte block of data out of two 16 byte blocks of transformed data. When the data size queued in the ring buffer 718 is of an appropriate size for transmission to the requesting device, the channel control logic 702 transmits the transformed data to the requesting device in step 814. In one embodiment, if there is more data to be transmitted to the requesting device after step 814 has been completed, the channel control logic 702 repeats the steps outlined in flow chart 800, starting at step 802.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A direct memory access (DMA) controller, comprising:
a control circuit adapted to receive device control information and to generate DMA transfer signals;
a converter adapted to receive DMA transferred data and convert the DMA transferred data into transformed data; and
a plurality of DMA channel interface circuits adapted to receive the DMA transfer signals and the transformed data.

2. The DMA controller of claim 1, wherein the converter is adapted to encrypt the DMA transferred data using cryptographic circuitry to convert the DMA transferred data into transformed data.

3. The DMA controller of claim 2, wherein the cryptographic circuitry comprises Advanced Encryption Standard compliant circuitry.

4. The DMA controller of claim 1, wherein the converter is adapted to decrypt the DMA transferred data using cryptographic circuitry to convert the DMA transferred data into transformed data.

5. The DMA controller of claim 4, wherein the cryptographic circuitry comprises Advanced Encryption Standard compliant circuitry.

6. The DMA controller of claim 1, wherein the converter is adapted to encode the DMA transferred data using error detection and correction circuitry to convert the DMA transferred data into transformed data.

7. The DMA controller of claim 1, wherein the converter is adapted to decode the DMA transferred data using error detection and correction circuitry to convert the DMA transferred data into transformed data.

8. The DMA controller of claim 1, wherein the converter is adapted to convert the DMA transferred data into transformed data the data by use of checksums.

9. An electronic device, comprising:
a display adapted to display program icons;
a user interface adapted to interact with the display program icons;
a central processing unit adapted to run programs associated with the display program icons; and
a DMA controller adapted to receive DMA transferred data from a target device, convert the DMA transferred data into transformed data, and transmit the transformed data to a requesting device.

10. The electronic device of claim 9, wherein the DMA controller is adapted to convert the DMA transferred data using cryptographic techniques.

11. The electronic device of claim 10, wherein the cryptographic techniques include Advanced Encryption Standard encryption and decryption techniques.

12. The electronic device of claim 10, wherein the cryptographic techniques include FAIRPLAY decryption techniques.

13. The electronic device of claim 9, wherein the DMA controller is adapted to convert the DMA transferred data using error detection and correction techniques.

14. The electronic device of claim 13, wherein the error detection techniques include utilizing a checksum error detection algorithm.

15. A method of converting data utilizing a DMA controller, comprising:
receiving DMA transferred data from a target device;
converting the DMA transferred data into transformed data in the DMA controller; and
transmitting the transformed data to a requesting device.

16. The method of claim 15, wherein converting the DMA transferred data is performed without first saving the transmitted data on an intermediate medium.

17. The method of claim 15, comprising deactivating a DMA channel when an error occurs while the DMA channel is in use.

18. The method of claim 17, comprising logging and reporting the deactivating of the DMA channel when the error occurs.

19. The method of claim 17, comprising determining the number of bytes transferred before the DMA channel was deactivated.

20. The method of claim 15, comprising deactivating a DMA channel when the DMA controller ceases to receive DMA transferred data from the target device.

21. A method of converting data, comprising:
receiving a DMA transfer request from a requesting device at a DMA controller;
scheduling a DMA transfer based on the DMA transfer request;
transmitting DMA transfer signals from the DMA controller to a target device,
receiving DMA transferred data from the target device;
converting the DMA transferred data into transformed data; and
transmitting the transformed data to the requesting device.

22. The method of claim 21, comprising buffering the transferred data prior to converting the DMA transferred data into transformed data.

23. The method of claim 22, comprising buffering the transformed data subsequent to converting the DMA transferred data into transformed data.

24. The method of claim 21, wherein converting the DMA transferred data into transformed data comprises using error correction or cryptographic techniques.
